(19) United States
(12) Patent Application Publication
(10) Pub. No.: US 2013/0285583 A1
(43) Pub. Date: Oct. 31, 2013

(54) DRIVE WITH CONNECTABLE LOAD ELEMENT

(71) Applicant: Rolf Strothmann, Saarbrucken (DE)

(72) Inventor: Rolf Strothmann, Saarbrucken (DE)

(21) Appl. No.: 13/877,623

(22) PCT Filed: Oct. 4, 2011
(86) PCT No.: PCT/DE2011/050039

§ 371 Date: Apr. 3, 2013

(30) Foreign Application Priority Data
Oct. 4, 2010 (DE) 10 2010 047 235.2

(51) Int. Cl. H02P 3/02

(52) U.S. Cl. CPC H02P 3/02
USPC 318/380

(57) ABSTRACT

A drive with an electric machine which can be operated as a motor for generating a positive drive force and as a generator for generating a negative drive force (braking force), a rechargeable battery, which supplies power to the electric machine in the motor operating mode and can be recharged by the electric machine in generator operating mode, and devices including a load resistor for limiting the charging of the rechargeable battery. The limiting devices also have devices for generating a flow which dissipates heat upstream of the load resistor.

The invention relates to a drive with an electrical machine which can be operated as a motor for producing a positive drive force and as a generator for producing a negative drive force (decelerating force), an accumulator which supplies the electrical machine with current when operating as a motor and which can be charged by the electrical machine when operating as a generator, and devices comprising a load resistance for limiting the charge of the accumulator. The invention further relates to an element usable particularly for such a drive for forming an electrical load comprising a load resistance.

Electrical devices of the above mentioned type, which facilitate a recovery of drive energy, have long been known and are used in various land vehicles. The hybrid vehicles which have gained importance recently, also comprise such a drive which is combined with an internal combustion engine, which can generate a decelerating force when operating downhill as a generator, wherein the battery to be charged can form the load necessary for producing the decelerating force. When there is the threat of overloading the accumulator, the operation is switched to the aforementioned load resistance which facilitates a further flow of the generator current without further charging the accumulator.

It is the object of the invention to provide a novel drive or a novel load element of the above mentioned type with a load resistance which is reduced in accordance with structural size.

The drive according to the invention which meets this object is characterized in that the limiting devices further include devices for producing a flow which withdraws heat from the load resistance. Correspondingly, the element for forming an electrical load is characterized by a conveying element for producing a flow which removes heat from the load resistance.

The load resistance can advantageously have small spatial dimensions and, thus, may also have a low weight. As a result of the heat removal by means of the flow in accordance with the invention, it is possible, with the resistance value remaining the same, to reduce the cross section of the line and also the length of the line. The heat removal prevents excessively high temperatures which would impair the resistance material, particularly its shape stability.

In accordance with a preferred embodiment of the invention, while different flow media including flowable liquids can be used for forming the flow, the flow generating devices are provided for producing an air flow, for which ambient air is available to an unlimited extent.

Advantageously, a flow is produced which, before it reaches the load resistance, has flowed around or/and through the electrical machine or/and the accumulator. In this manner, an additional cooling of the electrical machine or/and the accumulator can be achieved.

In accordance with another useful further development of the invention, the flow generating devices include guiding devices which concentrate the flow toward the load resistance, particularly a conical channel wall which ensures compacting of the flow at the load resistance.

A conveying element producing the flow of the flow producing device can also be drivable by a separate drive motor or/and by the mentioned electrical machine itself. In the latter case, a load element may possibly require only the load resistance which is, in accordance with a preferred embodiment of the invention, a blade wheel as it is used, for example, in an electrical blow dryer.

Preferably, the blade wheel is arranged coaxially with the axis of rotation of the electrical machine or of the separate drive motor.

In accordance with a particularly preferred embodiment of the invention, the load resistance or/and the flow producing devices are integrated in a structural unit comprising the electrical machine or/and a structural unit comprising the accumulator. Advantageously, such integration contributes to the compact structural configuration of the drive.

The separate drive motor or/and the electrical machine is advantageously constructed as a multiple-phase machine with phase strands switched in a star configuration, wherein particularly the separate drive motor or/and the electrical machine comprises a device for determining the position of rotation of the rotor with the aid of evaluation of the potential at the star point. The latter motor can be of very simple construction without special parts for determining the position of rotation of the rotor and, thus, has a high reliability which makes it possible to prevent a failure of the motor and, thus, a burning through of the load resistance.

In the following, the invention will be explained in further detail with the aid of embodiments and the enclosed drawings referring to the embodiments. In the drawing:

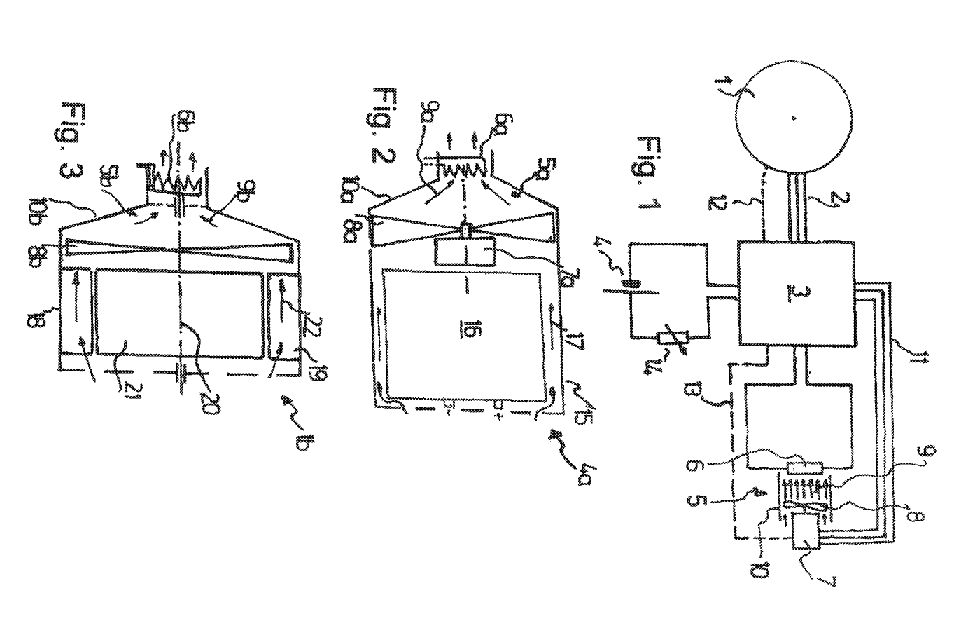

FIG. 1 shows in a schematic illustration a drive according to the invention,

FIG. 2 shows an accumulator structure, into which a load element according to the invention is integrated,

FIG. 3 shows a structural motor unit with an integrated load element according to the invention.

A drive schematically illustrated in FIG. 1 which may be, for example, an auxiliary drive for a bicycle, comprises a three-phase synchronous motor 1 which is in connection through a phase conductor 2 to a control device 3 which includes a power circuit. The control device 3 connects the synchronous motor 1 in accordance with the pulse width modulation process in a phase-like manner to an accumulator 4. In addition, the synchronous motor 1 can be connected through the control device 3 to a load element 5.

The load element 5 comprises a load resistance 6, a blade wheel 8 driven by a motor 7 for generating an air flow 9 for flowing around the load resistance 6, as well as flow guide plates 10 for concentrating the air flow 9 against the load resistance 6.

The motor 7 also is a three-phase synchronous motor which is in connection through phase conductors 11 to the control device 3.

The phase conductor as well as the synchronous motor 1 and the motor 7 are switched in a star configuration. The star point of the synchronous motor 1 is connected with the control device 3 through a line 12 and the star point of the motor 7 is connected with the control device 3 through a line 13.

A resistance 14 switched in series with the accumulator 4 may be controllable and may be a component part of the control device 3 which includes the power circuit.

During operation, for example, of a bicycle which uses the drive of FIG. 1 as an auxiliary drive, the synchronous motor 1 produces a forwardly directed drive force during travel in a plane or uphill. The accumulator 4 provides the operating current necessary for the operation of the motor.

During downhill operation, the control device 3 can ensure that the synchronous motor 1 operates as a generator and produces a rearwardly directed decelerating force. The electrical energy generated by reversing the mechanical decelerating work flows in the normal case into the accumulator 4 which, together with the resistor 14, forms the load resistance required for producing the decelerating force by the synchronous motor 1. The control device 3 adjusts the maximum permissible charging current for the accumulator while taking into consideration the respective accumulator voltage.

The control device 3 monitors the accumulator voltage depending on the charging state. When the maximum permissible accumulator voltage is reached i.e. at the highest possible charge of the accumulator, the control device 3 switches from the accumulator 4 to the load element 5 as the decelerating load for the synchronous motor 1, so that no further charging, which would be damaging to the accumulator, can occur.

Advantageously, the load resistance 6 of the load element 5, which in the illustrated embodiment is shaped approximately like the heating coil of a blow dryer, can—because of the cooling air flow 9—be constructed with a small line cross section and a short line length and, thus, with overall small dimensions and a low weight. It is understood that cooling by the air flow 9 is dimensioned in such a way that no temperatures occur which impair the material of the load resistance.

The dimensions of the load resistance 6 can be so small that the load element 5 can be integrated without problems in an accumulator or motor, as can be seen in FIGS. 2 and 3.

An accumulator component 4a, shown in FIG. 2, comprises an outer housing 15 in which, in addition to an accumulator cell 16, a load element 5a with a load resistance 6a and a structural group of a blade wheel 8a and a motor 7a can be accommodated. The air flow 9a produced by the blade wheel 8a is concentrated by a conical guide plate 10a and is conducted onto the load resistance 6a. A suction flow 17 of the air flow 9a on the side of the blade wheel 8a facing away from the load resistance 6a flows around and cools the accumulator cell 16.

In accordance with FIG. 3, in a housing 18 of a motor unit lb provided with air inlet and outlet openings, a load element 5b of a load resistance 6b and a blade wheel 8b is accommodated in addition to an annular stator 19 and a rotor 21 rotatable about an axis 20. The blade wheel 8b which is coaxial with the axis of rotation 20 is connected to a rotor 21 and produces an air flow 9b which, by means of a conical guide plate 10b, is concentrated toward the load resistance 6b. An intake flow 22 of the air flow 9b flows through the electric motor with a cooling effect.

The structural unit shown in FIG. 3 composed of electric motor and load element could be expanded by means of an accumulator cell which is additionally accommodated in the housing 18.

In accordance with another embodiment, the coil of the drive motor 7 or 7a for the blade wheel 8 or 8a could itself form the load resistance, and the air flow produced by the blade wheel could flow through the drive motor while cooling the coil.

1-11. (canceled)

12. A Drive, comprising: an electrical machine which for producing a positive drive force is operable as a motor and for producing a negative drive force (decelerating force) is operable as a generator; an accumulator that supplies current to the electrical machine when the electrical machine is operated as a motor and is chargeable with current by the electrical machine when the electrical machine is operated as a generator; and devices creating a load resistance for limiting the charge of the accumulator, the limiting devices additionally including devices for producing a flow that conducts heat away from the load resistance.

13. The drive according to claim 12, wherein the flow producing devices are configured to produce an air flow.

14. The drive according to claim 12, wherein the flow producing devices are operative to produce an intake flow that flows around or/and through the electrical machine or/and the accumulator.

15. The drive according to claim 12, wherein the flow producing devices comprise guide devices that concentrate the flow toward the load resistance.

16. The drive according to claim 12, wherein the flow producing devices include a separate drive motor for a conveying element that produces the flow or/and a conveying element that is drivable by the electrical machine for producing the flow.

17. The drive according to claim 16, wherein the conveying element is a blade wheel.

18. The drive according to claim 17, wherein the blade wheel is arranged coaxially relative to an axis of rotation of the electrical machine.

19. The drive according to claim 12, wherein the load resistance or/and the flow producing devices are integrated in a structural unit that comprises the electrical machine or/and a structural unit that comprises the accumulator.

20. The drive according to claim 16, wherein the separate drive motor or/and the electrical machine are constructed as multiple-phase machines with phase strands switched in a star configuration.

21. The drive according to claim 20, wherein the separate drive motor or/and the electrical machine each have a device for determining a position of rotation of a rotor based on an evaluation of a potential at the star point.

22. An element for forming an electrical load for use in a drive according to claim 12, comprising: a load resistance; and a conveying element for producing a flow that removes heat from the load resistance.
